(19) United States
(12) Patent Application Publication
(10) Pub. No.: US 2010/0216518 A1
(43) Pub. Date: Aug. 26, 2010

(54) FOLDABLE MOBILE COMMUNICATION DEVICE

(75) Inventors: Alasdair McPhail, London (GB); Franz von Sales Pfeiffer, Ulm/Einsingen (DE); Tim Sebastian Sobig, Ulm (DE); Ulrich Buschmann, Rammingen (DE); Roger Montane Gil, Blaustein (DE)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/391,932

(22) Filed: Feb. 24, 2009

(51) Int. Cl. H04M 1/02

(52) U.S. Cl. 455/567; 455/575.3

(57) ABSTRACT

In accordance with an example embodiment of the present invention, an apparatus comprises a joint which is configured to pivotably couple two housings of the apparatus and comprises a visual indicator; and a controller which is configured to control the visual indicator.

### TECHNICAL FIELD

The present application relates to a foldable type mobile communication device in which a reminder to users of any missing event is carried out by visible signaling.

### BACKGROUND

Foldable communication devices, e.g., clamshell phones or communicator type phones, have become very popular perhaps by attraction of small physical size or different user experience.

When there is an incoming call to a foldable phone, the user receives an indication of the incoming call, and is typically supposed to answer the phone call within a predefined time period. In a similar manner, the phone gives a short time indication for Short Message Service (SMS) which reminds the user about an arrival of an SMS. However, it happens sometimes that the user is not able to pick up the phone when an incoming call arrives or can not react to the notification of an SMS arrival within a short time. Even though the phone typically gives a reminder of missing call or message receiving on the display screen, the reminder may not be visible for the user if the phone is in folded position or the display is hidden when the phone is in standby mode.

### SUMMARY

Various aspects of examples of the invention are set out in the claims

According to a first aspect of the present invention, there is a provided apparatus comprising a joint configured to pivotably couple two housings of the apparatus, where the joint comprises a visual indicator; and a controller configured to control the visual indicator.

According to a second aspect of the present invention, there is a provided method comprising pivotably jointing two housings of an apparatus by a joint; and controlling a visual indicator by a controller. The visual indicator is configured to be situated in the joint.

According to a third aspect of the present invention, there is a provided computer program product comprising a computer-readable medium bearing computer program code embodied therein for use with a computer. The computer program code comprises code for controlling a visual indicator. The visual indicator is configured to be situated in a joint, and the joint configured to pivotably couple two housings of the apparatus.

According to a fourth aspect of the present invention, there is a provided processor configured to execute a computer code. The processor comprises means for controlling a means for visually indicating. The means for visually indicating situated in a jointing means for pivotably coupling two housings of an apparatus.

According to a fifth aspect of the present invention, there is a provided apparatus comprising a jointing means for pivotably coupling two housings of the apparatus, and a means for controlling a means for visually indicating. The jointing means comprises the means for visually indicating.

### BRIEF DESCRIPTION OF THE DRAWINGS

For a more complete understanding of example embodiments of the present invention, reference is now made to the following descriptions taken in connection with the accompanying drawings in which:

FIG. 1a shows an external appearance view of a foldable communication device according to an example embodiment in an open position.

FIG. 1b shows an external appearance view of a foldable communication device according to an example embodiment in a folded position.

FIG. 2a illustrates another external appearance view of a foldable communication device according to an example embodiment in an open position when an event activation has not been responded.

FIG. 2b illustrates another external appearance view of a foldable communication device according to an example embodiment in a folded position when an event activation has not been responded.

FIG. 3 is a view of a partially disassembled foldable communication device according to an example embodiment of the invention.

FIG. 4a illustrates a further external appearance view of a foldable communication device according to an example embodiment in an open position when an event activation has not been responded.

FIG. 4b illustrates a further external appearance view of a foldable communication device according to an example embodiment in a folded position when an event activation has not been responded.

FIG. 5 illustrates a block diagram of the major circuitry components of the device in FIGS. 1, 2, 4 according to an example embodiment.

FIG. 6 gives a flowchart illustrating a method according to an example embodiment.

FIG. 7 gives two light-emitting patterns in an example embodiment.

### DETAILED DESCRIPTION OF THE DRAWINGS

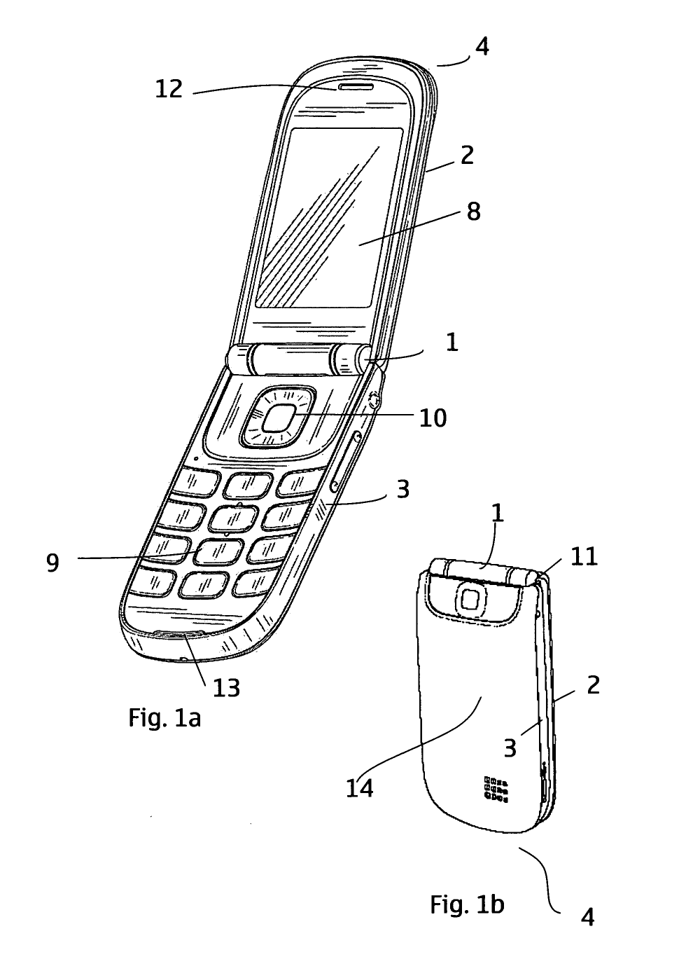

An example embodiment of the present invention and its potential advantage are described by referring to FIG. 1 through FIG. 7 of the drawings.

A foldable communication device typically comprises two housings coupled by a hinge mechanism, where a display screen is disposed on a first part housing and many operation keys are disposed on a second part housing. These two housings may generally be in a folded position, where the two housings are folded together, one upon the other, such that screen of the first housing surface is facing the keys of the second part housing; or in an open position, where the two housings are in an angle, next to each other. The hinge may be configured in many different ways such that the foldable communication device is able to be openned and closed by using nails or pushing buttons, etc. For some kind of foldable communication device, at least one extra display is disposed on the first part housing and is always on the face of the device when the device is in a folded position.

FIG. 1a shows an external appearance view of a foldable communication device 4 according to one example embodiment in an open position. FIG. 1b shows an external appearance view of a foldable communication device 4 according to an example embodiment in a folded position. Referring to FIGS. 1a and 1b, the foldable communication device 4 includes a hinge 1, a first part housing 2 and a second part housing 3 which is coupled by the hinge 1, a first display 8 which is disposed on the inner side surface of the first part housing 2, a keypad 9 with soft keys 10 which can be programmed to perform different functions and disposed on an inner side surface of the second part housing 3, an antenna configuration 11 which is either completely or partially contained within the communication device housing, an ear-piece 12, a microphone 13, and a battery 14 behind a battery cover. The hinge 1 may be, but is not limited to, any kind of coupling or connection mean, joint or a turning joint, swivel, mean for linking two parts in a rotatable way. The inner side surfaces of the first and second part housing 2, 3 are invisible to the user when the device is in folded position. The antenna configuration 11 may include one or more separate antennas for communicating in different frequency bands and located in different places in the device. In another example embodiment, the foldable communication device 4 may comprise a second display disposed on an outside surface of the first part housing 2. All the displays may use various display technologies or mechanisms, e.g. a Liquid Crystal Display (LCD), a Digital Light Processing (DLP), a Plasma Screen display, a Liquid Crystal on Silicon (LCOS) display, a Cathode Ray Tube (CRT) display, a Light Emitting Diode (LED) Backlight Display, an Organic Light Emitting Diode (OLED), a Surface Conduction Electron-Emitter Display (SED), or an Electronic Paper Display, wherein a display can be combined with mirror effect, or touch screen, etc.

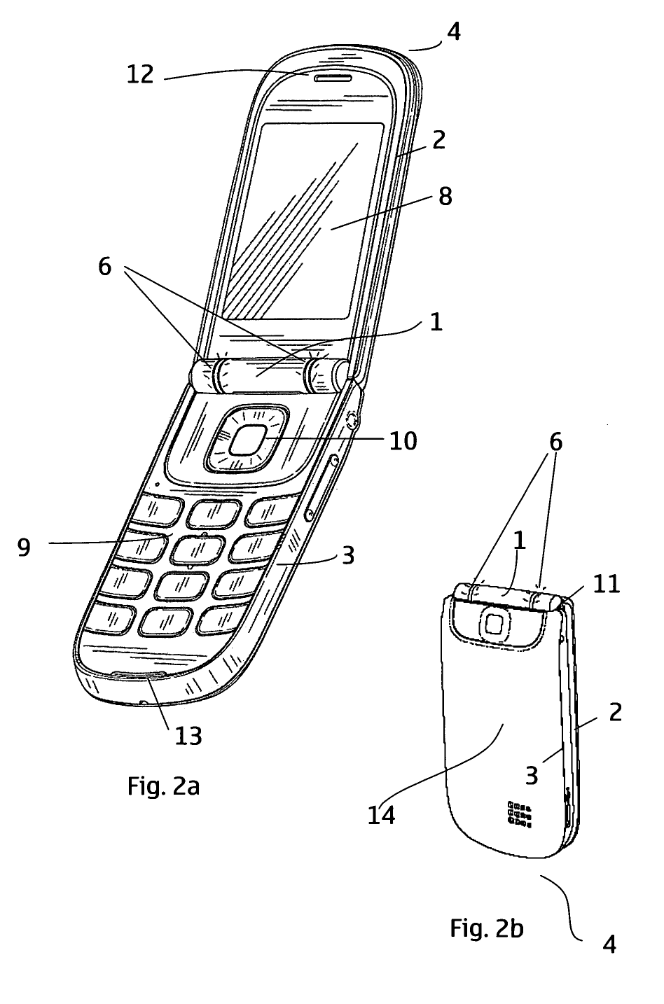

FIG. 2a illustrates another external appearance view of a foldable communication device according to an example embodiment in an open position when an event notification has not been responded. FIG. 2b illustrates another external appearance view of a foldable communication device according to an example embodiment in a folded position when an event notification has not been responded. The event could be any activities related to the applications or functions in a communication device, either requiring or independent of the wireless communication function of the device, e.g. a phone call, a message or an email, a calendar or task reminder, a low battery warning, etc. When a new event is activated, the user may not be able to react to the event notification by for example opening a connection, acknowledging or confirming the notification or responding to a query, at the time of being e.g. when the device is not located around the user, or the user is busy in doing something else, or the user ignores the event on any purpose, etc. The event notification is missed, and the indicator 6 brings the user a visual reminder of the missed notification. The visual reminder may be a light illumination e.g., a light pulse/blink/breathe/fading according to FIGS. 2a and 2b, or any kinds of mechanical solutions that may bring users attention to the device by visible signaling. The indicator 6 may be visible to the user from all the angles no matter how the device is placed, e.g. when the device 4 is in folded position as shown in FIG. 2b or when the device 4 is in open position as shown in FIG. 2a.

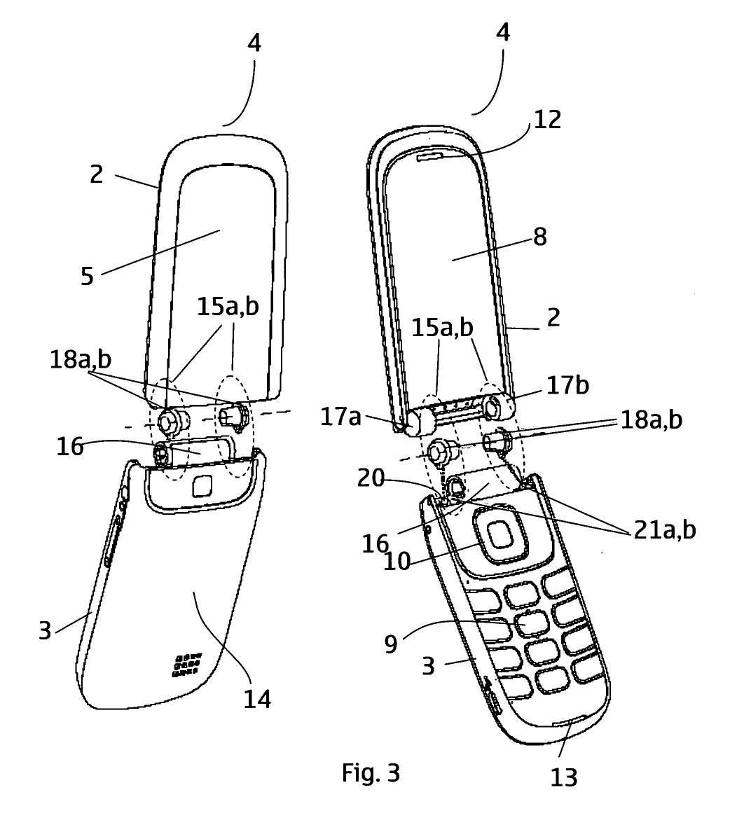

Referring to FIG. 3, a partially disassembled hinge for coupling the first part housing 2 and the second part housing 3 in a foldable communication device according to an example embodiment comprises a bearing section 16, 17a, 17b, and joint sections 15a, 15b. Each part of joint sections 15a, 15b comprises at least one washer 18a, 18b which also has the function of bearing. The bearing sections 17a, 17b are coupled with the first part housing 2 and the bearing section 16 is coupled with the second part housing 3. At each joint section 15a, 15b, one end of each washer 18a, 18b is supported by bearing sections 16 while the other end is stored into the bearing section 17a, 17b in such a manner that the first part housing 2 is coupled with the second part housing 3. A substrate 20, a key sheet together with the inner surface and the outside surface of the lower part housing 3 are stacked and sandwiched. The substrate 20 is for mounting electronic components and may be a printed circuit board, a printed wire board or a flexible circuit board, etc.

In an example embodiment, the indicator 6 functions with aid of light sources, in this example one or more LEDs 21a, 21b mounted on convenient positions on the substrate 20, one or more light guides which may be simply gaps or molded using a white or color diffusing material. Light guides are configured in such a manner that the light generated by the one or more LEDs 21a, 21b is all the way guided through from the inner part to the outer part of the washer 18a, 18 b. The joint sections 15a, 15b on the hinge may illuminate light when the one or more LEDs 21a, 21b are turned on, or the light source emits light. When the indicator is placed or formed around the longitudinal axis of the hinge, the light emission on the indicator 6 may be easily seen by the user no matter how the foldable communication device is placed.

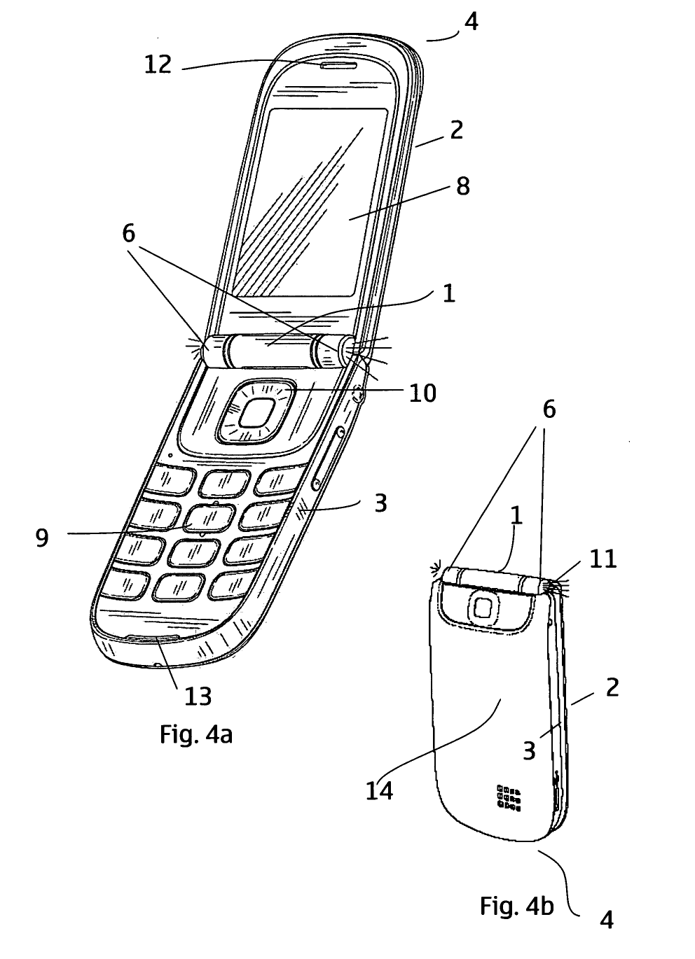

FIGS. 4a and 4b illustrates a further external appearance view of a foldable communication device according to an example embodiment in an open position and folded position respectively when an event notification is missed. In an example embodiment, the one or more light guides may be configured in such a manner that the light generated by at least one of the LEDs 21a, 21b is guided through the inner part of washer 18a, 18b to the at least one end of bearing section 17a, 17b. The end of the hinge may illuminate light when the one or more LEDs 21a, 21b is turned on as illuminated on FIGS. 4a and 4b. In this example embodiment, the indicator 6 is placed or formed at the end of the longitudinal axis of the hinge.

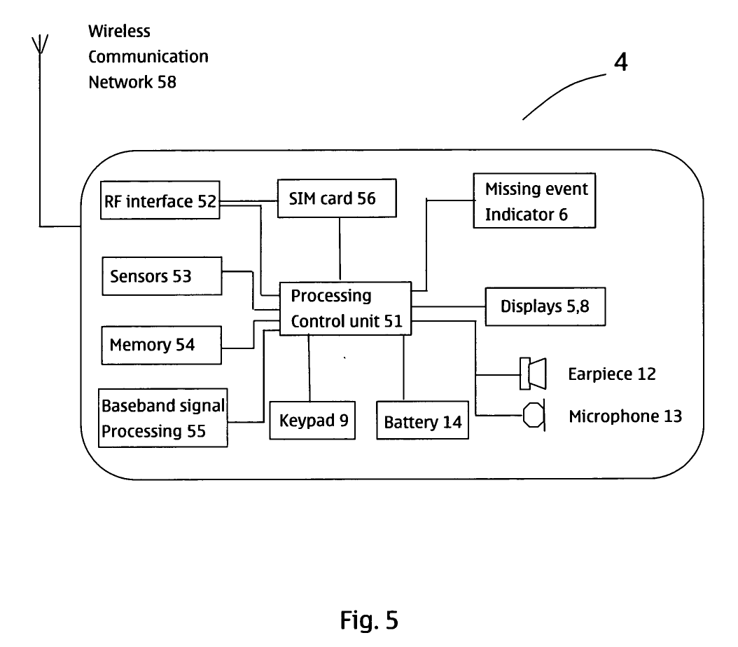

FIG. 5 shows a block diagram of circuitry components of the foldable communication device 4 according to an example embodiment. Radio Frequency (RF) interface 52 is for transmitting signal to and receiving signal from a wireless communication network 58, including but not limited to general mobile communication network for Second Generation (2G), Third Generation (3G), Fourth Generation (4G) wireless communication, e.g. GSM (Global System for Mobile communications), (W)CDMA ((Wideband) Code Division Multiple Access), PDC (Personal Digital Cellular), GPRS (General Packet Radio Service), etc, near field communication network or GPS (Global Positioning System) network. The RF interface 52 may comprise at least one antenna. Different antennas are used for transmitting radio signals based on different communication standards. One or more Subscriber Identity Module (SIM) cards 56 for storing user's subscription information and other data are also needed for wireless communications. Signal processing is carried out in the signal processing data path 55 under the control of a processing control unit 51. The processing control unit 51 comprises a microprocessor and may execute instructions preinstalled in a memory 54 and/or in response to the input commands from a keypad 9, a sensor 53, a microphone/speaker 13, or a display interface 5, 8. There may be more than one memory in the device 4.

A sensor 53 may be used in different places in the foldable communication device 4 for detecting a physical quantity or tactile input, and converting it into a signal for the processing control unit 51. For example, a sensor 53 may output a “close” signal or an “open” signal to the processing control unit 51 when the foldable communication device 4 is in a folded or an open position. A folded or an open position may be defined by a position of the two housings in relation to each others, For example, it may be defined but not limited that the device 4 is in an opening position when the inner angle between housings attached by and in relation to the hinge is larger than 30°; and correspondingly in a folded position when the angle is less than 30°. In an example of embodiment for a display with LED behind, when the control unit 51 detects an arrival of a “close” signal, the control unit 51 may turn off the LED behind the display screen so the display screen is not easy to be seen or it may be completely hidden. The control unit 51 may turn on the LED behind the display screen when an “open” signal is sent from a sensor 53. The processing control unit 51 monitors the status of battery 14 and indicates the power level on the display 5, 8. The processing control unit 51 may also monitor or be informed of a new event activation, e.g. an incoming phone call arrival, a missed phone call notification, a Short Message Service (SMS), a Multimedia Message Service (MMS), an email, a battery level and status reminder or a calendar reminder, etc, and control the visual indicator 6 accordingly.

In an example of embodiment, when an event activation that requests user's response, e.g. a phone call, arrives, it is received at the RF interface 52. The processing control unit 51 may correspondingly activate an incoming call reminder which has been pre-selected by the user. The reminder may be a ring tone, voice reminder that have been preinstalled in the memory 54, a vibration and/or a text reminder displayed on the display interface 5, 8. The display interface 5, 8 is also illuminated, e.g. by the LEDs behind it, in the mean time so that the user is able to see a text reminder e.g. the number/ID of caller when the device 4 is in an open position. If the control unit 51 is notified that the user has confirmed the incoming call reminder in a predefined time period and ready to answer the phone by either pressing a talk button on the keypad 9 or activating a talking status by unfolding the foldable communication device in any kind of mechanical solutions, the processing control unit 51 will turn on the microphone/speaker 13, ear-piece 12 and create a connection from a baseband signal processing data path 55 to the RF interface 52. The speech signal is normally coded and modulated before it is transfered to the destination through wireless communication network 58, and then decoded and demodulated before it is outputted from the ear-piece 12. The incoming call reminder disappears once the phone connection is established. Generally, an event notification for alerting a user is ended, in response to the user action, like response, acknowledgement, or confirmation of the event notification.

Besides the sensor 53, a counter may be needed to control the operation mode in the foldable communication device 4. When the user has answered the phone, the device is in active mode. After the conversation is finished and the connection is closed, the device may continuously be in active mode until a predefined time period runs out. Then the device 4 is typically turned to a power-saving standby mode.

In an example of embodiment, when a message or an email arrives, the processing control unit 51 may send an incoming message reminder which has been pre-selected by the user and may be e.g. a ringtone, voice reminder that have been preinstalled in the memory 54, a vibration, an icon indicator on the display interface 5, 8 or a text reminder. Normally, the ringtone or voice reminder for a message or an email arrival is much shorter or repeated fewer times than that for an incoming call. The message or email is then automatically saved in the memory 54 or outside e.g. communication network server for enabling the user to check it in the future. When a calendar reminder or a low battery warning arrives in an example of an embodiment, the processing control unit 51 may notify the user of the event activation by an icon or text on the display interface 5, 8. Both the icon indicator and the text reminder will disappear when the processing control unit 51 is notified that the event notification has been confirmed, e.g. by either checking the inbox or dismissing the reminder.

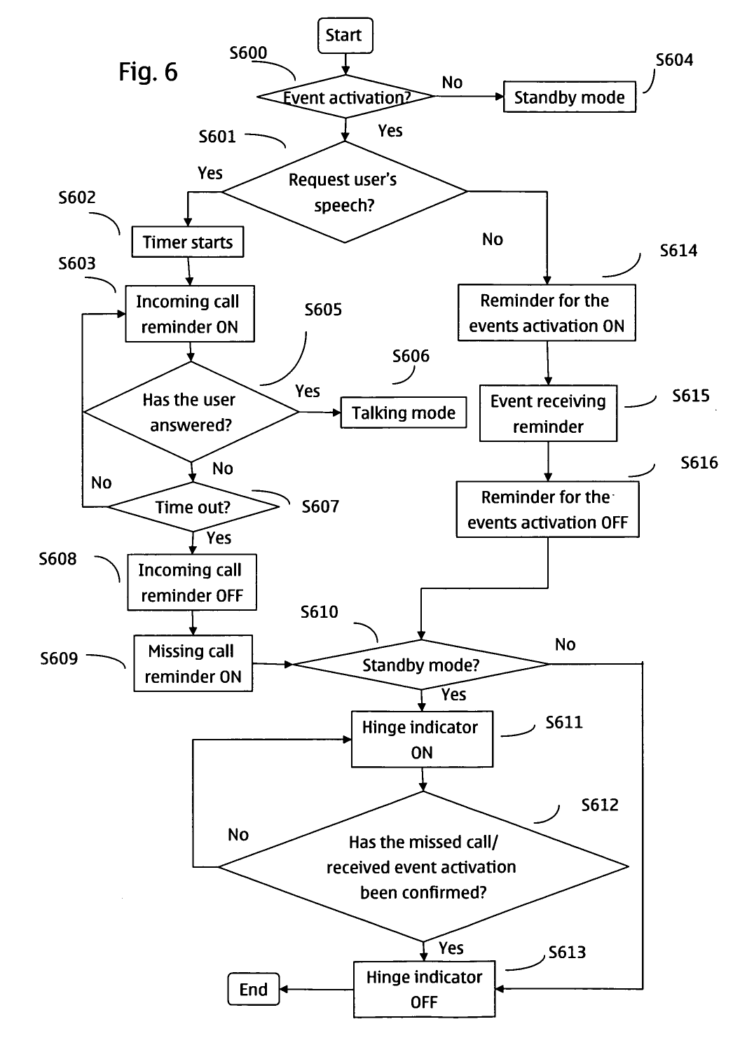

FIG. 6 is a flowchart illustrating a method according to an example embodiment. When there is an event notification S600, the processing control unit 51 first checks if the user's speech is requested for responding the event activation S601. If so, a timer starts counting S602 and the control unit 51 turns on the incoming call reminder which may be a ringtone, a voice, a song, a vibration, light indication and/or a text reminder S603. The device is in receiving mode and the RF interface 52 is receiving the incoming call signal. Otherwise, the foldable communication device is in standby mode S604. The processing control unit 51 checks if the user has answered the incoming call S605 in a predefined time period. In the case that the user responds the incoming call reminder and the signal path from the RF interface 52 to the baseband signal processing data path 55 and further to the earpiece 12/microphone 13 is connected within a certain time period, the foldable communication device is turned to normal talking mode or operating mode S606. However, there may be many reasons that user is not able to answer the call, for example, the user is busy in talking with another calling party on the device, or the user is not interested in answering the call, or the user is not available to answer the call at the moment. If the notification of the incoming call arrival is still not responded before the time runs out S607, all the incoming call reminders are turned off S608 and a missed call text reminder is shown on the display S609.

Next, the control unit 51 continues checking the status of the display interface 5, 8 in the foldable communication device 4 S610. If the foldable communication device 4 is in standby mode, the device 4 is in a folded position and/or the display interface 5, 8 is invisible to the user or not illuminated. The processing control unit 51 turns on the visual indicator 6 once it is notified that the device 4 is in standby mode S611. The processing control unit 51 checks a possible response to the event activation, e.g. confirming receipt of the missing call or ignoring S612. The visual indicator 6 is turned off after the missing call reminder S613 on the display has been confirmed. If the device 4 is in active mode and in an opening position, the display 5, 8 is visible to the user and normally illuminated. In one example embodiment, it may not be necessary to turn on any visual indicator 6 to remind the user of the missed call when the user can read the missed call reminder on the display so unnecessary power consumption is avoided. In another example embodiment, the indicator 6 may be turned on right after the missed call reminder displays to notify the user of the missed call, or then non-responded event.

If responding to an event activation does not request the user's speech, e.g. a message including but not limited to an SMS, an MMS, or an email, a low battery warning, or a calendar/task reminder, the control unit 51 typically turns on the reminder for the event activation which may be a ringtone, a voice, a song, a vibration S614 and then usually displays some icon or text on the display screen 5, 8 S615. The reminder is normally short and is turned off shortly after S616 except the text and/or icon reminder displayed on the screen. The control unit 51 checks the status of the device 4 and/or the display interface S610. The visual indicator 6 is turned on S611 once it is notified that the device 4 is in standby mode, e.g the device 4 is in a folded position and/or the display interface 5, 8 is hidden or non-illuminated. The processing control unit 51 continues checking the user's reaction to the event notification S612. The visual indicator 6 is turned off after the user confirms receipt of the reminder for the events activation S613.

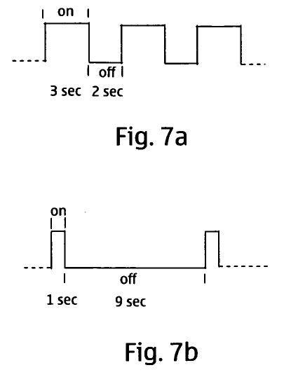

The light-emitting patterns on the visual indicator 6 are controlled by the processing control unit 51. The pattern may be chosen in according to the type of incoming events, e.g. an incoming event which request the user's speech or not. In an example embodiment, when an incoming call is missed, the control unit 51 may cause the visual indicator 6 to blink periodically in a manner that it is turned on for 3 seconds and then off for 2 second as illustrated in FIG. 7a. In contrast, when a message or email arrives, the control unit 51 may cause the visual indicator 6 to blink periodically in a manner that it is turned on for 1 second and then off for 9 seconds as illustrated in FIG. 7b. The light patterns may be altering patterns, comprising various blinking and/or fading series, or random visual effects among others. From the blinking type the user may easily identify whether an incoming phone call has been missed or a message/email has just arrived.

The light emitting patterns on the visual indicator 6 are not limited to blink but may be continuous lightning. In an example embodiment, the visual indicator 6 emits continuous light with different colors according to the type of incoming events. The light-emitting with intermittern blinking or continuous lightning combined with different color may enable the user to distinguish plural types of notifications, initiated by various applications or functions of the user apparatus.

The light-emitting pattern may be chosen according to the group type of the calling party, e.g., friend, boss/manager, colleague, family or relatives, etc. In an example of embodiment, when an incoming call from boss or manager is missed, the control unit 51 may cause the visual indicator 6 integrated in the middle part of the hinge blink as illustrated in FIGS. 2a and 2b periodically with the color red in a manner that it is turned on for 3 second and then off for 2 second as illustrated in FIG. 7a. The obvious location of the indicator 6 plus the eye-catching color red may draw the user's attention and remind the user of importance of this missed call. When an incoming call from a friend is missed, the control unit 51 may cause the visual indicator 6 integrated on the ends of the hinge blink as illustrated in FIGS. 4a and 4b with the color green in a similar manner to all the other missing calls for example as illustrated in FIG. 7a. The user may easily identify the type of the missed call from a different location of the indicator 6 and a harmonic color green.

The light-emitting pattern may be chosen according to the type of entity that generates the message/email, the reminder etc. In an example embodiment, if an incoming message or email arrival has not been confirmed by the user, it may be determined whether the message or email is a spam, a company commercial or a normal communication. When a reminder occurs, it may be determined where, or by which function or application, the reminder was initiated. For example whether this reminder is from a power management device or from a calendar. Based at least partially on the determination, the light-emitting pattern may be changed.

The light-emitting pattern may be chosen according to the procedure for unanswered phone call or unconfirmed incoming events control. In an example embodiment, if an incoming event arrives in middle of the night and the user is sleeping or if the user is not available to access the communication device in a short time, continuously remaining the visual indicator 6 on will waste battery power. It is possible to set up a time limit of remaining the visual indicator 6 on and monitor how long the time has been running. In case that the visual indicator is remained on longer than a predetermined time limit, it may be turned off from the power saving perspective. On the other hand, it may cause the user easily to forget or ignore the missing event when the user becomes available again to access the communication device 4. A practical way may be turning the light-emitting pattern of the visual indicator 6 to a power saving mode, e.g. changing continuous lightning to intermitten blinking, or reducing the time of being on during blinking, or reducing the illumination power with the time running, etc. Another practical way may be activating the visual indicator 6 when a move of the device 4 is detected via e.g. an accelerator sensor.

Furthermore, the light-emitting patterns may be chosen according to various combinations of the variables which are not limited to the example embodiments described above. The light-emitting patterns may also be determined by the shape, the type of the indicator 6, or the configuration of the foldable communication device 4, the radio communication scheme, etc.

Without in any limiting the scope, interpretation, or application of the claims appearing below, it is possible that a technical effect of one or more of the example embodiments disclosed herein may be to surely indicate the user of a missing event for a foldable communication device no matter how the device is placed. Another possible technical effect of one or more of the example embodiments disclosed herein may be to provide the user a foldable communication device with a very straightforward indication without changing the basic design of the device. Another technical effect of one or more of the example embodiments disclosed herein may be to visually and clearly draw the user's attention on the occurrence of unanswered phone call or unconfirmed reminder, even when the user is being away from the foldable communication device or in a dark place.

It will be appreciated that many modifications may be made to the example embodiments described above. It should be realized that the foregoing examples should not be constructed as any limiting.

Embodiments of the present invention may be implemented in software, hardware, application logic or a combination of software, hardware and application logic. Part of the software, application logic and/or hardware may reside on the communication device 4, part of the software, application logic and/or hardware may reside on communication network service. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising:
a joint configured to pivotably couple two housing of the apparatus;
the joint comprising a visual indicator; and
a controller configured to control the visual indicator.

2-37. (canceled)

38. An apparatus according to claim 1, wherein the controller is configured to activate the visual indicator in response to a non-responded event notification.

39. An apparatus according to claim 38, wherein the event notification is related to an application or a function in the apparatus.

40. An apparatus according to claim 38, wherein the event notification is initiated by one of applications or functions in the apparatus: an arriving phone call, a missed call notification, a message reminder or a status reminder.

41. An apparatus according to claim 1, comprising a substrate configured to mount a light source.

42. An apparatus according to claim 41, comprising a lightguide configured to guide light from the light source to the visual indicator.

43. An apparatus according to claim 1, wherein the housings comprise at least one display interface, and the controller is further configured to monitor the status of the said at least one of display interface.

44. An apparatus according to claim 1, wherein the joint comprises at least one washer, a bearing section coupled to one of the two housings of the apparatus, and another bearing section coupled to the other of the two housings of the apparatus.

45. An apparatus according to claim 1, wherein the controller is configured to control the visual indicator based at least partly on one of: position of the housings in relation to each others, mode of the apparatus, status of a display of the apparatus, or status of an event notification.

46. An apparatus according to claim 1, wherein the visual indicator comprises at least one optical component.

47. An apparatus according to claim 1, wherein the visual indicator comprises at least one light emitting component.

48. An apparatus according to claim 1, wherein the visual indicator is configured to emit light according to an illumination pattern based at least partly on at least the event notification.

49. An apparatus according to claim 1, wherein the controller is configured to change the pattern with a predefined time period.

50. An apparatus according to claim 1, wherein the joint has a D shape or a ring shape.

51. A foldable communication device comprising the apparatus according to claim 1.

52. A method, comprising:
pivotably jointing two housings of an apparatus by a joint; and
controlling a visual indicator by a controller, wherein the visual indicator is configured to be situated in the joint.

53. A method according to claim 52, comprising activating the visual indicator in response to a non-responded event notification.

54. A method according to any of claim 53, wherein the event notification is related to and initiated by one of an application or a function in the apparatus: an arriving phone call, a missing call notification, a message reminder, a status reminder.

55. A computer program product comprising a computer-readable medium bearing computer program code embodied therein for use with a computer, the computer program code comprising
code for controlling a visual indicator;
wherein the visual indicator is configured to be situated in a joint, and the joint configured to pivotably couple two housings of the apparatus.

56. An apparatus, comprising:
a joint means for pivotably coupling two housings of the apparatus;
the joint means comprising a means for visually indicating; and
a means for controlling the means for visually indicating.
